(19) United States
(12) Patent Application Publication
(10) Pub. No.: US 2003/0069860 A1
(43) Pub. Date: Apr. 10, 2003

(54) Method for stamping information carriers

(76) Inventors: Anders Berndtsson, Kullavik (SE); Franz Pitz, Emmingen-Liptingen (DE)

Correspondence Address: STRIKER , STRIKER & STENBY, 103 East Neck Road, Huntington, NY, 11743, US

(21) Appl. No.: 10/265,949

(22) Filed: Oct. 7, 2002

(30) Foreign Application Priority Data
Oct. 6, 2001 (DE) 101 49 416.5

(51) Int. Cl. G06G 7/00

(52) U.S. Cl. 705/400

(57) ABSTRACT

The invention relates to a method for stamping information carriers, in particular, card-shaped carriers, such as credit cards, identification cards, customer cards, bank cards and the like by means of two type carriers. One type carrier holds raised type and the other type carrier holds recessed type in the form of numbers and letters. The type carriers stamp the desired characters into the material of the information carrier held between the two type carriers. In the inventive method, multiple characters of at least one line are simultaneously stamped in a single stamping process. All characters in a line thereby can be stamped in a single stamping process or successively in successive stamping processes.

### BACKGROUND OF THE INVENTION

The present invention relates to a method for stamping information carriers, in particular, card-shaped carriers, such as credit cards, identification cards, customer cards, bank cards and the like.

In addition, the invention relates to a device for performing this method.

These types of information carriers, in particular, credit cards, which are made out of a stampable material (such as plastic) are machined during manufacture in various way, whereby in different lines, characters in the form of numbers, letters and the like are produced by stamping, especially punching out the material of the information carrier. Thus, for example, a line with a relatively large type of numbers is produced, which represent identification numbers of the card holder. This number sequence, for example, has 16 positions with credit cards, which means that the sequence comprises 16 characters in the form of numbers.

In a further line that is spaced from and parallel to the number sequence, a further line is generally provided in credit cards with the date information that defines the period of validity of the card. In another spaced and parallel line on the credit card, characters in the form of letters are provided, which indicate the name of the credit card holder. These individual characters in the form of numbers and/or letters or the like are stamped into the material of the information carrier in a known manner, that is, individually, character by character. An upper radial type carrier is used, which is rotatable about a vertical axis with reference to a station in which the information carrier is held, whereby the respective selected type of this type carrier is brought into position by turning of this type carrier. Beneath this type carrier, a correspondingly disposed type carrier is disposed. The respective type is found on the corresponding, facing broadsides of the two type carriers and is grouped there at the edge in the peripheral direction in succession. For stamping each individual character, the information carrier is brought into the stamping position by means of a two-axis positioning device and the character subsequently is stamped into the information carrier by means of a stamp on each respective component carrier with the type of the upper type carrier. Such a method, in which character after character are successively stamped, is expensive and time-consuming in that, for example, only 240 cards per hour can be stamped.

### SUMMARY OF THE INVENTION

The invention addresses the underlying problem of improving the method of the above-described type so that a faster stamping of the information carrier is possible, and therewith, a greater speed and resultantly greater output is achievable.

The problem is resolved with the present invention, in that multiple characters of at least one line are stamped simultaneously in a single stamping process, thereby achieving a substantially increased machining speed with a substantially greater output results. Practice indicates that with the inventive method, the stamping process proceeds 20 times or more faster and that, for example, an output of cards between 6,000 and 8,000 pieces per hour is achievable.

The simultaneous stamping of multiple characters of a line in a single stamping process is therefore made possible in that the individual, respective type, or the type carrier carrying the associated recessed type, is rotatably adjustable and displaceable with reference to the axes parallel to the plane of the information carrier, such that line type, multiple type, or recessed type to be associated, are placed in the ready position next to one another along a row. Upon the operation of pressure with the information carrier held there, multiple characters in a line can be simultaneously stamped.

The invention relates also to a device for performing the above method.

The method and device according to the present invention are unusually simple. It allows a large number of information carriers, in particular, cards, to be stamped with a much greater speed per unit of time. The device is contemplated for use as a stand-alone unit as well as an in-line embodiment, and in this connection, is integrated in specific machining processes of information carriers, especially cards and personalization processes.

Also, when the process and device according to the present invention is suited for stamping cards made of stampable material, such as plastic, it is also contemplated that also other information carriers, particularly documents and other stampable material, are machinable in this manner.

### BRIEF DESCRIPTION OF THE DRAWINGS

FIG. 1 is a schematic plan view of a part of a device for stamping information carriers according to a first embodiment, which is provided on a rotary cycle machine;

FIG. 2 is a schematic section along line II-II in FIG. 1 with a partial side view of the device according to the first embodiment;

FIG. 3 is a schematic plan view of a part of the device for stamping information carriers according to a second embodiment, which is provided on a linear cycle machine;

FIG. 4 is a partial sectional side view of a stamping station in FIG. 3, in an enlarged representation; and

FIG. 5 is a schematic side view of the stamping station in the direction of the arrow V in FIG. 4.

### DETAILED DESCRIPTION OF THE PREFERRED EMBODIMENTS

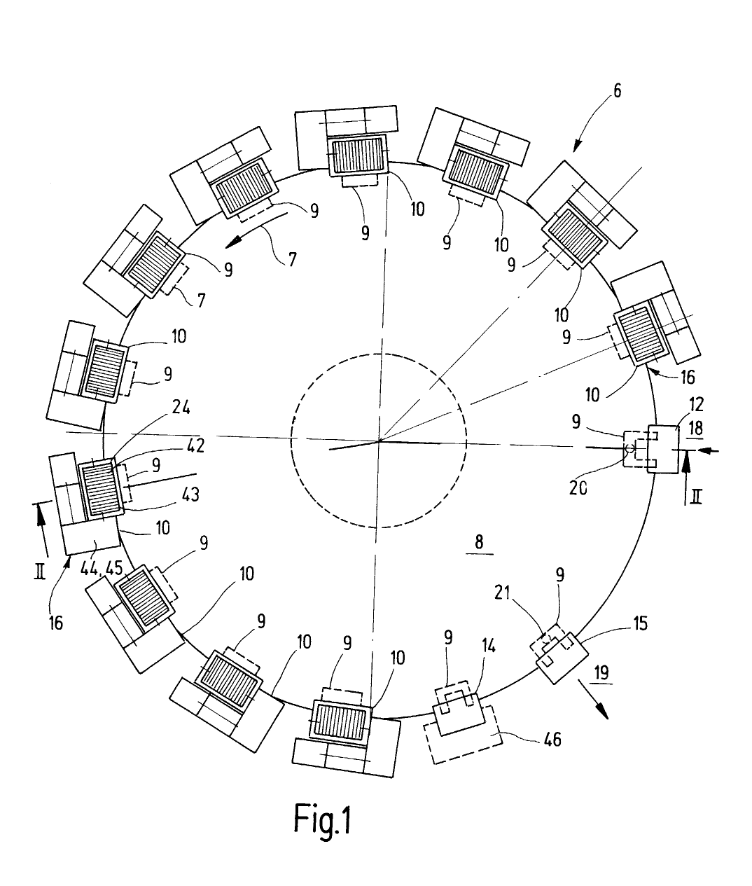

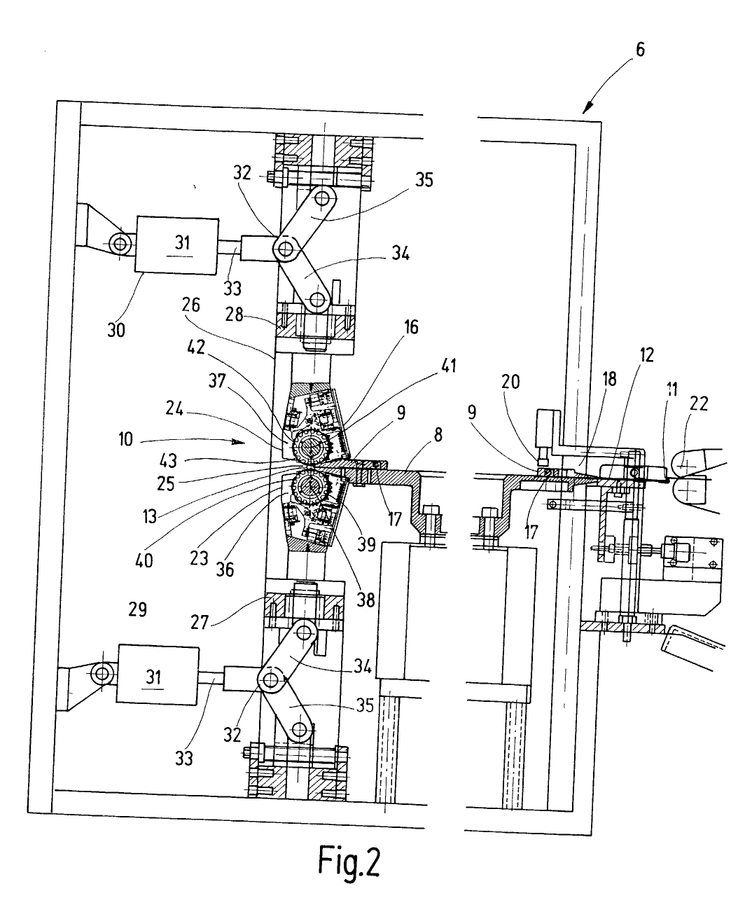

In FIGS. 1 and 2, only those parts of a device 10 are shown schematically that are necessary for explanation of the inventive method for stamping information carriers 11 and the device 10 according to the present invention. In FIGS. 1 and 2, a rotary cycle machine 6 is shown, which has a rotary attachment 8 that is rotatably driven by means of a common drive device in a cyclical manner according to arrow 6 about a vertical axis. The rotary attachment carries identical holding devices 9, preferably arranged at the same sized circumferential angle distances, each holding device 9 for a respective, card-shaped information carrier 12, 13, 14, 15, shown only schematically. With the rotary attachment 8, also in the remaining holding devices 9, corresponding card-shaped information carriers are held, which in FIG. 1 are not visible. With this particular card-shaped information carrier, for example, credit cards, identification cards, customer cards, bank cards and other similar cards can be handled, most of which are made from plastic. As the information carrier 11 through 15, instead of cards, however, also other documents are contemplated.

The rotary cycle machine 6, according to the illustrated embodiment in FIGS. 1 and 2, has a total of 11 devices 10 for stamping the information carrier 11 through 15, whereby these individual devices 10 are arranged stationary around the rotary attachment 8 and are placed from one another at the same circumferential angle distance. Each device 10 is formed as a stamping station 16, of which only one stamping station 16 is shown in FIG. 2, whereby all stamping stations are similarly constructed. Therefore, it is sufficient here to explain an individual unit with reference to the stamping station 16.

Each holding device 9 is formed as a clamping device similar to a clip, which by means of a pressure spring 17 is held automatically in a clamping position, in which, by means of the clamping device, an information carrier, such as the information carrier 12-15 and so on, is securedly held. In the region of the supply point 18 and the output point 19, which are referenced in FIG. 1 only with an arrow, a stationary operation device 20, 21 is provided, which is designated only schematically as a pressure-operated working cylinder. The operation device 20, 21, upon running of the rotary attachment 8, advances a holding device 9 in the area of the operation device 20, 21 and through a lifting operation from below, opens the holding device 9, so that near the supply point 18, an information carrier 12 can be taken up from the holding device, and near the output point 19, an information carrier 15 held in the holding device 9 can be released and carried away.

The rotary cycle machine 6 is associated with the supply point 18 with a supply device 22 for an information carrier 11, shown only schematically, which is part of a common, not further shown feeder. At the output point 19, a common output device for the information carrier 15 and subsequent carriers is disposed, which is not further shown. Each device 10, which is formed as a stamping station 16, has a first, lower stamping press 23 and an opposite, second stamping press 24 arranged above the first press 23, with a column 25 there between. The stamping presses 23, 24 are held in a support 26, such that both stamping presses 23, 24 in their starting positions are held with a distance from one another with a column 25 between them and are held upon the rotational operation of the rotary attachment 8 in the arrow direction 7, such that an information carrier 13 held in the holding device can be moved into this column. Hereafter, both stamping presses 23, 24, through relative movement in the vertical direction (FIG. 2) are power-operated into one another, whereby the stamping presses 23, 24 stamp multiple characters or all characters in a line in a single stamping process simultaneously on the information carrier 13 held between the two presses 23, 24. After this stamping process, the two stamping presses 23, 24 are moved again away from one another in the vertical direction according to FIG. 2, returned to their starting positions after release of the previously held information carrier 13, which, upon subsequent, further operation of the rotary attachment 8 is further transported to the next, successive device 10 in the form of a similar pressing station 16 in the direction of the arrow.

For movement of the stamping presses 23, 24 onto and away from one another, both stamping presses 23, 24 are displaceably mounted in the support 26. On a part 27 of the stamping press 23, or on a part 28 of the stamping press 24, which is the respective holding part of the associated stamping press and which is displaceable with this part, an associated drive device 29 or 30 engages, by means of which the respective stamping press 23, 24 is movable between the stamping position and the starting position. The drive devices 29, 30 are formed identically; each has a respective pressure-operated working cylinder 31 and a lever arrangement 32, formed according to the bent or elbow lever principle, on which the working cylinder 31 operates. In FIG. 2, the working cylinder 31 is shown in the position corresponding to the starting position of the stamping press 23, 24. For moving the stamping presses 23 24 into their stamping positions, the piston rod 33 of the working cylinder 31 extends out and presses both levers 34, 35 of the lever arrangement 32 first in a substantially vertical position, in which the levers 34, 35 align with one another along a vertical line. This position corresponds to the stamping position of the stamping presses 23, 24. Upon further extension of the piston rod 33, the lever 34, 35 again moves into an angle position to one another and, thereby, approximately in a position that is the mirror-image of the position shown in FIG. 2. In this position, the respective working cylinder 31 remains with the levers 34, 35 until the next machining time and stamping process, in which the piston rod 33 is moved back into the position shown in FIG. 2. A working stroke of the working cylinder 31 corresponds to a movement of the stamping presses 23, 24 from the starting position into their stamping positions and again into their starting positions. Through this progression of movement, a relatively uniform transition from the stamping position to the starting position and back is provided for the movement of the stamping presses 23, 24 with the smoothest acceleration and deceleration as possible, whereby vibrations and vibration loads of the stamping presses 23, 24 are avoided or at least reduced.

Each stamping press 23, 24 of the individual stamping stations 16 is formed in a first embodiment as a known, completely automatic, adjustable numbering mechanism 36, 37. This type of fully automatic adjustable numbering mechanism is shown and disclosed in EP 0 718 112 A1; reference is made to this disclosure in order to avoid unnecessary repetition regarding the particular construction. The respective numbering mechanism 36, 37 is modified here for stamping of characters with the information carriers 11-15 such that the individual numbering wheels disposed adjacent to one another along the longitudinal intermediate axis 38 act as type wheels 39 of the first stamping press 23, and as such, are provided on the circumferential teeth with raised type 40 suitable for stamping. Analogously, the second numbering mechanism 37 that forms the stamping press 24 is constructed such that its coaxially arranged numbering wheels, arranged along the intermediate axis 41, act as type wheels 42 and as such, carry recessed type 43 on the ends of their teeth. The longitudinal intermediate axes 38 and 41 run parallel to one another and within a common vertical plane.

With the first stamping press 23, the arrangement is such that multiple, adjacently arrangement type wheels 39 of the same type, which respectively are provided with raised type 40 on the ends of their teeth, are combined in a coaxial arrangement to this first stamping press 23, whereby this stamping press 23, like this numbering mechanism 36, is adjustably, fully automatic and thereby, has an individual drive device 44, which has a drive motor and an associated gear and which is only schematically shown in FIG. 1. Analogously, the upper stamping press 24, near which in FIG. 1 one of the eleven stamping stations 16 is visible, is formed from the numbering mechanism 37 and constructed such that multiple, identical, coaxial type wheels 42 are arranged along the longitudinal intermediate axis 41 near one another and combined in a drum-like manner, whereby these type wheels 42 carry respective recessed type 43 on the ends of their teeth, and also, this numbering mechanism 37 is fully automatically adjustable and has an individual drive unit 45 with a drive motor (not shown) and associated gear. In the plan view in FIG. 1, only the upper second stamping press 24 is visible of stamping station 16, whose individual type wheels 42, arranged in a drum-type configuration, have recessed type 43 on the ends of their teeth. With this arrangement, the characters are pressed from below to above on the material of the information carrier 13 during the stamping process. Instead of this arrangement, the stamping presses 23, 24 also can be exchanged, so that the characters are pressed from above to below.

Each stamping press 23, 24 of each stamping station 16 has more than twelve type wheels 39, 42, for example, 24 wheels or also more, up to, for example 27 type wheels, which is the case for the embodiment to be described next. Each of the type wheels 39 and 42 has separate, for example, 16 different types about its circumference. Based on the construction of each stamping press 23, 24 as a fully automatic, adjustable numbering mechanism 36 or 37 of the known type, each stamping press 23, 24 of each type wheel 39 or 42 of this stamping press 23, 24 is fully, automatically adjustable, whereby the adjustment of the stamping mechanism 23, 24 of the respective stamping station 16 occurs during the cyclical transport of the information carrier 11-15 on the rotary attachment 8 in the direction of the arrow 27.

In the first embodiment in FIG. 1 and 2, a total of 11 identical stamping stations 16 are arranged behind one another along the circular path, which the rotary attachment 8 with its individual holding devices 9 and information carriers 11-15 runs through. It is to be understood that alternatively, these individual stamping stations 16 can be also linearly arranged behind one another, whereby the machine, then, is formed as a linear cycle machine, in which the respective information carriers 11-15 move along the linearly placed stamping stations 16 after one another for stamping. It is to be understood that all pressing stations 16 are adjusted during the cycled transport of the information carriers 11-15 at the same time on the characters to be stamped on the respective information carriers 11-15. By the adjustment of two stamping mechanisms 23, 24 forming a stamping station 16, the respective oppositely disposed type wheels 39, 42 are adjusted onto the same type, so that with the first stamping mechanism 23, a raised type 40 and with the other stamping press 24, a recessed type 43 of the same manner are opposite to one another, so that upon initiation of the stamping process, the material, for example, the plastic, of the information carrier 11-15 is corresponding deformed and thereby, the corresponding characters are stamped.

In FIG. 1, it is shown in dotted lines that in connection with the eleventh stamping station 16, for example, a stationary upper surface treatment station 46 can be provided, in which the upper surface of the information carrier 14 onto which the stamping process was performed is treated, for example, colored or covered with a foil, and so on.

It is to be understood that in addition to the above forms, at least one additional stamping station 16 can be provided, for example, a chip coding station and/or a magnet coding station and/or a printing station with ink jet or laser printing and/or a camera checking station or the like, which are positioned along the transport path of the individual information carriers 11-15 at a suitable location. This is the case for the rotary cycle machine 6 as well as for the linear arrangement of the stamping station, for example, as a linear cycle machine.

The rotary cycle machine 6 with the individual devices 10 in the form of stamping stations 16 makes possible the following process. Each device 10 in the form of a stamping station 16 serves to stamp the card-shaped information carriers 11-15 and on, such as, for example, credit cards, identification cards, customer cards, bank cards and so on, which are made out of a stampable plastic or another type of stampable material.

In this connection, corresponding characters in the form of numbers, letters and so on are pressed in the material of the respective information carrier 11-15 by means of two blocks of the respective type wheels 39 on one side and 42 on the other side. The type wheel 39 has raised type 40 and the other type wheel 42 has corresponding recessed type 43. In particular, the characters are stamped out onto this material, whereby during the stamping process, the respective information carrier 11-15 is held between these groups of type wheels 39 and 42. The type wheels 39 are combined in a drum-like fashion for the first stamping mechanism 23 and the other type wheels 42 for the second stamping mechanism 24, so that in an individual stamping process upon the information carrier 11-15, multiple characters of a line, which are parallel to the longitudinal intermediate axes 38, 41, are simultaneously stamped. In this manner, it is possible to stamp the entire characters in a line in a single stamping process. When this is not possible or not desired, all characters in a line can be pressed after one another in successive stamping processes. For example, with the round cycle machine 6 in FIGS. 1 and 2, in the first stamping station 16 following the supply point 18, a part of the characters in a line can be stamped in a first stamping process, for example, only each second character of this line, and following this, the information carrier 12 is transported in the direction of the arrow 7 to the next, successive stamping station 16, in which, then, a further part, for example, the remaining part of the characters of the same line can be stamped. In this manner, a complete line may be stamped on the information carrier 12 by performing two, successive operations at two successive stamping stations 16. If all of the characters in a line are not stamped onto the information carrier 12, then this can occur in a next, subsequent stamping station 16 and further, subsequent stamping station 16, and so on.

If a round cycle machine 6 has only two successive stamping stations 16, which stamp the characters of a single line, in the first stamping station 16, only a part of the characters of a line can be stamped, and in a subsequent step in the next stamping station 16, the remaining part of the characters of this line can be stamped. If two stamping stations do not achieve this result, then each stamping station also can be used for a two-part or more stamping process on the same information carrier 12. For example, in one stamping process, a part of the characters of a line, for example, only each second character, can be stamped. in this connection, a relative filling-in between the type carriers in the form of the type wheels 39, 42 of the stamping station 16 on the one side and the information carrier 12 on the other side in the direction of this line takes place in the gaps between the already stamped characters, so that a further part, for example, the remaining part of the characters of the same line, can be stamped in the same stamping station 16. The information carrier 12 to be stamped is placed, then, relative to the stationary stamping station 16 parallel to the longitudinal intermediate axes 38, 41. This has the advantage that one has only a minimal number of stamping stations, however, with the disadvantage that the information carrier 12 must be placed back and forth relative to the stamping station 16.

With a single stamping station 16 of the described type, after stamping the characters of one line on the information carrier 16, more characters in a second and further line can also be stamped. For stamping the characters of the second and further lines, a relative filling-in takes place between the stamping mechanisms 23, 24 on the one side and the information carrier 12 on the other side in a direction transverse, in particular perpendicular to, the course of the line, that is, to the longitudinal intermediate axes 38, 41 at a respective line spacing, so that then, in the same stamping station 16, the characters of the second and further lines can be stamped.

With the rotary cycle machine 6 according to FIGS. 1 and 2, conforming stamping stations 16 can be connected, in order to stamp different characters on a supplied information carrier 12 one after another in the subsequent stamping stations 16, and indeed, such characters of one line and characters of the next, subsequent and further lines, so that after processing the information carrier 12 through the entire 11 stamping stations 16, entire characters can be stamped onto the information carrier 12 in successive stamping processes. In this connection, so many information carriers 12 as stamping stations are provided. Such an arrangement corresponding to FIGS. 1 and 2 has the advantage of maximal speed with a greater output of stamped information carriers 12 per unit time. The invention makes it possible to stamp, for example, between 6,000 and 10,000 information carriers per hour with the desired characters.

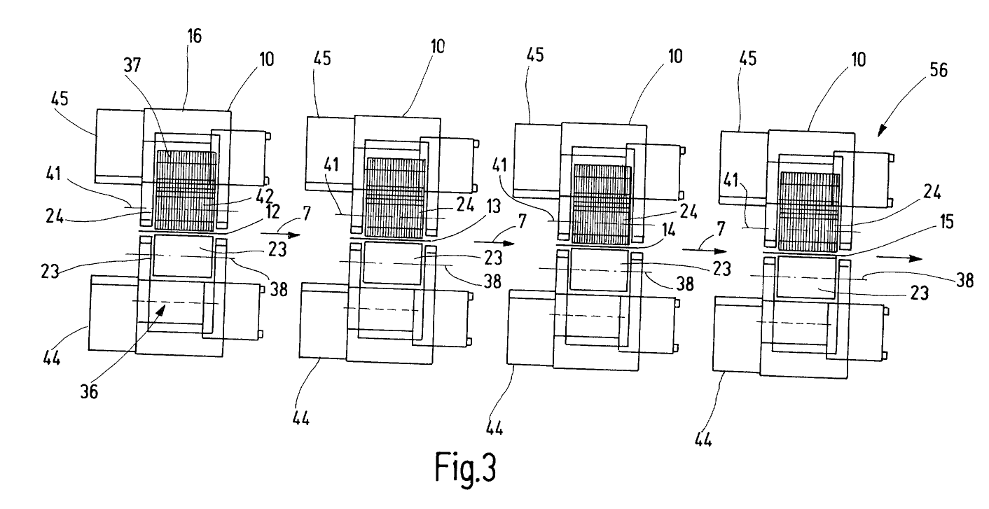

In the second embodiment shown in FIGS. 3 through 5, individual devices 10 in the form of stamping stations 16 are designated with the same reference numerals for parts that correspond to the first embodiment. To avoid repetition, reference is made to the description of the first embodiment.

With the second embodiment, the individual stamping stations 16 are not arranged along a curve, rather linearly in a determined, uniform distance from one another, whereby this can be part of a linear cycle machine 56, for example, which is not further illustrated. The individual information carriers 12-15 are moved forward linearly and cyclically from one stamping station 16 to the next, successive stamping station 16, whereby also here, the individual information carriers 12-15 are securely held by means of holding devices (not further shown), so that they cannot be dislodged while the information carriers 12-15 are guided through the column 25 between the respective stamping presses 23, 24 of each stamping station 16, or while the stamping process in this column 25 is stopped. Also, when only four successive stamping stations 16 are shown as I FIG. 3, as in the first embodiment, also more stamping stations or fewer stamping stations can be provided. The manner of operation of stamping the information carriers 12-15 is the same at each stamping mechanism 23, 24 of each stamping station 16 as in the previously described first embodiment.

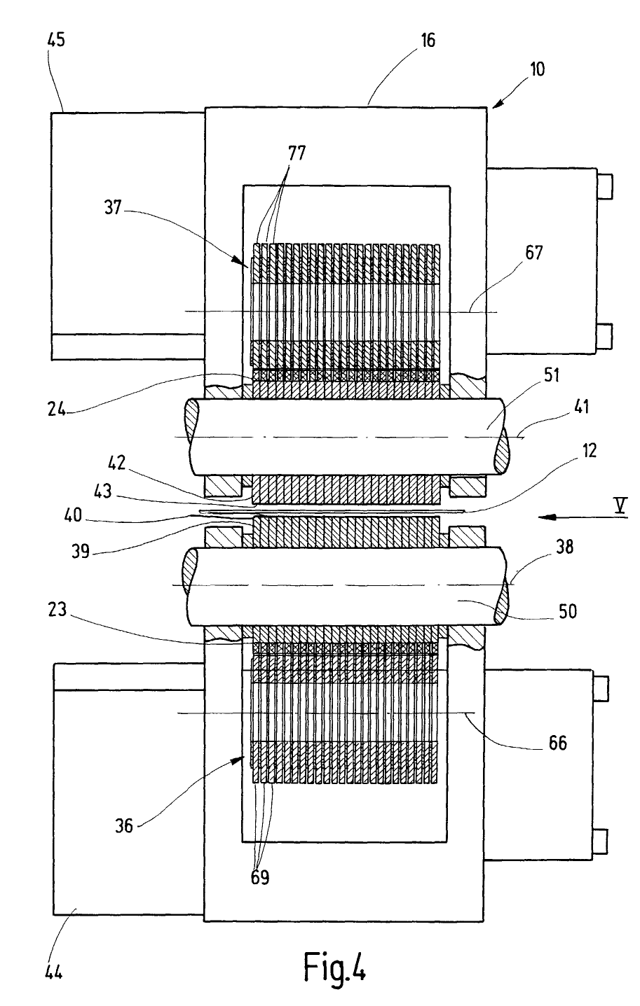

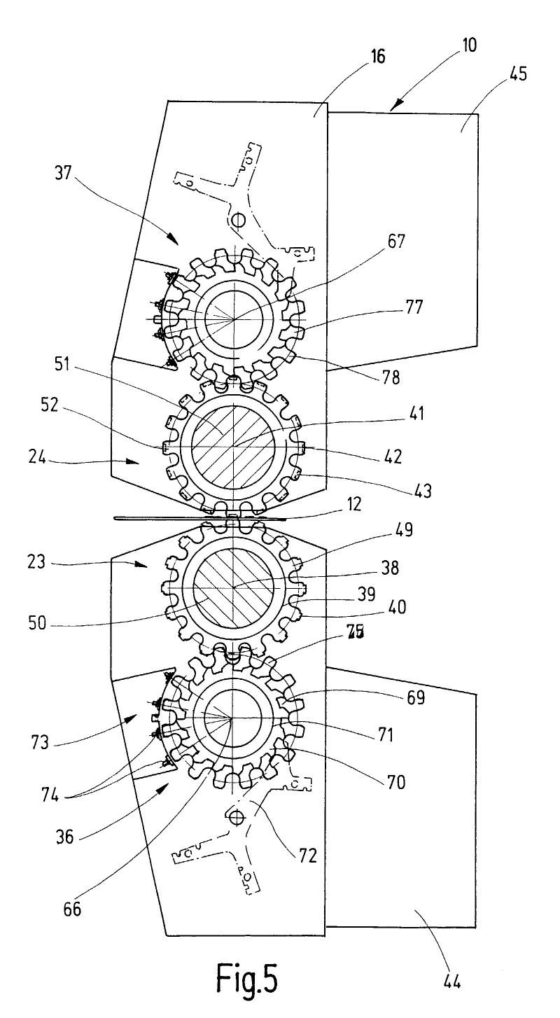

The second embodiment differs from the first embodiment, however, in that each stamping mechanism of a stamping station is driveably associated with a known, fully automatic adjustable numbering mechanism 36, 37, which with its drum axis 66, 67 run parallel to the respective longitudinal intermediate axes 36, 37. Also, the respective numbering mechanisms 36, 37 correspond accordingly, as is described in EP 0 718 112 A1, to which reference is made as to details to avoid repetition. In FIGS. 4 and 5, the numbering wheels 69 seated on the drum axis 66 of the numbering mechanism 66 is shown, as well as the locking disks 72 having teeth 70 and disposed between two numbering wheels 69. Each locking disk 71 is associated with a pawl or latch 72, of which one such latch 72 is shown in FIG. 5 with dotted lines. Each numbering wheel 69 is associated with a fixed probing or sensing device 73, as schematically shown in FIG. 5. The probing device 73 has four Hall sensors 74 arranged along the peripheral path of the numbering wheels 69 spaced from one another and having different polarity from individual permanent magnets, which are provided on each numbering wheel 69 and which are not shown.

The other, upper numbering mechanism 37 of FIGS. 4 and 5 is also constructed in the same manner, of which, likewise, the individual numbering wheels 77 coaxially arranged along the drum axis 67 are shown. The two numbering mechanisms 36, 37 are modified such that the numbering wheels 69, 77 are provided with respective gear wheels with corresponding driving teeth 75, 78. The type wheel 39 of the stamping press 23 as well as the type wheel 42 of the second stamping press 24 are in conformity there constructed as gear wheels 49, 52, which are engaged with the drive teeth 75, 78 of the numbering wheels 69, 77 of the respective, associated numbering mechanisms 36, 37, serving in this position as a drive, whereby the gear wheels 49, which form the type wheels 39 of the first stamping press, have raised type 40 at the end of the teeth. The gear wheels 52, which form the type wheels 42 of the second stamping press 24, have recessed type 43 on the ends of the teeth. Corresponding with FIGS. 4 and 5, the type wheels 39 of the first stamping press 23 are held near one another rotatably on an axis 50 and are held together in a manner that is not shown further. In a corresponding manner, the type wheels 42 of the second stamping press 24 are held coaxially and near one another rotatably on an axis 52 and are held together in a manner that is not shown further. The longitudinal intermediate axes 38, 41 run respectively parallel to the drum axis 66, 67 of the numbering mechanisms 36, 37.

The described form of the stamping station 16 of FIGS. 4 and 5 has the advantage that the type wheels of the stamping mechanisms 23, 24 can be very narrowly constructed, so that a greater number of type wheels 39 or 42 can be provided. Each stamping mechanisms 23, 24, for example, has up to 27 adjacently seated type wheels 39 or 42, which carry separately 16 type on the circumference. A further advantage of the form according to the second embodiment is that the respective axes 50, 51 have a relatively large diameter and can receive, therefore, a correspondingly large force. This form of the stamping mechanism 23, 24 makes it possible also to stamp very narrowly adjacent characters on an information carrier 12 in one stamping process, for example, to stamp all characters in one line in one stamping process. In other cases, where it is permitted to stamp all characters of one line or to stamp the characters in further, parallel lines requiring further stamping processes, as shown in FIG. 3, multiple, identical stamping stations 16 are arranged linearly in uniform distances, whereby the individual information carrier 12 to be stamped and others are fed through these individual stamping stations.

It will be understood that each of the elements described above, or two or more together, may also find a useful application in other types of constructions differing from the types described above.

While the invention has been illustrated and described herein as a method for stamping information carriers, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. Method for stamping information carriers (11 through 15), in particular card-shaped information carriers such as credit cards, identification cards, customer cards, bank cards or the like, comprising the following steps:
providing two type carriers (23, 24), wherein a first type carrier (23) has raised type (40) and a second type carrier has corresponding recessed type (43) in the form of numbers, letters and the like;
stamping selected characters corresponding to selected type in the form of numbers, letter and the like into a material comprising the information carrier, wherein said information carrier is held between the two type carriers (23, 24), wherein multiple characters of at least one line are simultaneously stamped in a single stamping process.

2. Method as defined in claim 1, wherein all of the characters of one line are stamped one after another in successive stamping processes.

3. Method as defined in claim 1, wherein in a first stamping process, a part of the characters of a line are stamped, wherein following said first stamping process, the information carrier (11-15) is moved linearly or along a curve to a successive stamping station (16), and wherein in said successive stamping station (16) in a second stamping process, a further part of the characters of the line are stamped.

4. Method as defined in claim 1, wherein after stamping of characters of one line, multiple characters in a second line and further lines are stamped on the information carrier (11 through 15).

5. Method as defined in claim 4, wherein for stamping the characters of the second line and further lines, the information carrier (11 through 15) is moved linearly or along a curve to a further, successive stamping station (16) and at said further, successive stamping station (16), the second line and further lines are stamped.

6. Method as defined in claim 1, wherein in a stamping process, a portion of the characters of a line are stamped, wherein after said stamping process, a relative filling-in of gaps between previously stamped characters takes place between the type carriers (23, 24) on one said and the information carrier (11 through 15) on the other side in a direction of said line, and wherein in a same stamping station (16), a further portion of the characters of the line are stamped.

7. Method as defined in claim 4, wherein for stamping of the characters, the second line and further lines of the information carrier (11 through 15), a relative filling-in between the type carriers (23, 24) on one side and the information carrier (11 through 15) on the other side occurs in a direction transverse to a course of the line at a respective line spacing and wherein in a same stamping station (16), characters in the second line and further lines are stamped.

8. Method as defined in claim 1, wherein all characters of a line are stamped in a single stamping process.

9. Method as defined in claim 1, wherein before a respective stamping process, the first type carrier (23) with raised type and the second type carrier (24) with recessed type are adjusted to a character to be stamped.

10. Method as defined in claim 1, wherein for simultaneous stamping of multiple characters of a line of the information carrier (11 through 15), multiple, adjacently arranged type carriers (23) with raised type (40) and multiple, associated, adjacently arranged type carriers (24) with respective recessed type (43) are power-operated through relative movement onto one another under stamping of characters of the information carrier (11 through 15) held between said type carriers (23, 24).

11. Device for performing the method of claim 1, wherein multiple, adjacently arranged type carriers, in particular type wheels (39), with respective raised type (40) are combined to a first stamping press (23) and multiple, adjacently arranged type carriers, in particular, type wheels (42) with respective recessed type (43) are combined to a second, opposite stamping press (24), wherein the first and second stamping presses (23, 24) define a column (25) there between, wherein the stamping presses (23, 24) are power-operated for stamping characters on the information carrier (11 through 15) and wherein after stamping, said stamping presses are again moved apart from one another.

12. Device as defined in claim 11, wherein the first stamping press (23) and the second, associated stamping press (24) are held to a stamping station (16) in combination in a support (26).

13. Device as defined in claim 11, wherein multiple stamping stations (16) are disposed linearly or along a curve, in particular a circular curve, behind one another.

14. Device as defined in claim 13, wherein multiple stamping stations (16) are arranged on a round cycle machine (6) or a linear cycle machine (56).

15. Device as defined in claim 11, wherein the respective information carrier (11 through 15) is transported cyclically and wherein during said transport, type carriers of each stamping press (23, 24) are adjusted simultaneously on the character to be stamped.

16. Device as defined in claim 11, wherein type carriers, in particular, type wheels (39, 42) of each stamping press (23, 24) are arranged coaxial to one another and combined in a drum-type manner.

17. Device as defined in claim 11, wherein each said stamping press (23, 24) has 24 to 27 type wheels (39, 42).

18. Device as defined in claim 11, further comprising a type wheel (39, 42), wherein said type wheel (39, 42) holds 16 separate types about its circumference.

19. Device as defined in claim 11, wherein said stamping presses comprise type wheels (39, 42), wherein said type wheels (39, 42) of each stamping press (23, 24) are fully automatically adjustable.

20. Device as defined in claim 11, further comprising stamping stations (16), wherein each stamping press (23, 24) of each station (16) is formed as a fully automatic, adjustable numbering mechanism (36, 37), wherein numbering wheels of said numbering mechanisms operates as a type wheel (39, 42), and wherein, as the type wheel (39) of the first stamping press (23), one of said numbering mechanisms carries raised type (40) and as the type wheel (42) of the corresponding second stamping press (24), one of said numbering mechanisms carries recessed type (43).

21. Device as defined in claim 11, wherein each stamping mechanism (23, 24) is driveably associated to a fully, automatically adjustable numbering mechanism (36, 37), wherein numbering wheels (69, 77) of said numbering mechanisms (36, 37) are provided with respective gear wheels with corresponding gear teeth (75, 78), and wherein the type wheels (39, 42) of each stamping press (23, 24) are formed as gear wheels (49, 52), wherein said gear wheels are positioned for driving to engage with the drive teeth (75, 78) of associated numbering wheels (69, 77) and wherein said gear wheels carry raised type (40) or recessed type (43).

22. Device as defined in claim 21, wherein the type wheels (39, 42) of each stamping press (23, 24) are held near one another rotatably on an axis (50, 51) and a longitudinal intermediate axis (38, 41) of this axis (50, 51) runs parallel to an axis (66, 67) of a respective associated numbering mechanism (36, 37).

23. Device as defined in claim 20, wherein each adjustable numbering mechanisms (36, 37) has an individual drive device (44, 45) with a drive motor and associated gear.

24. Device as defined in claim 11, wherein said stamping presses (23, 24) forming a stamping station (16) are mounted with a respective associated numbering mechanism (36, 37) in a support (26) to be adjustably moved into and away from one another.

25. Device as defined in claim 11, wherein a drive device (29, 30) engages on each stamping press (23, 24), wherein a respective stamping press (23, 240) is movable between a stamping position and a starting position by means of said drive device.

26. Device as defined in claim 25, wherein the drive device (29, 30) has respectively a pressure-operated working cylinder (31) and a lever arrangement (32), on which said working cylinder (31) operates.

27. Device as defined in claim 14, wherein said rotary cycle machine has a driveable rotary attachment (8) running in a cycle in a direction, wherein said rotary attachment (8) has holding devices (9) disposed thereon, wherein said holding devices (9) are arranged with a same circumferential angular spacing from one another as a respective information carrier (11 through 15).

28. Device as defined in claim 27, wherein said holding devices (9) are formed as clamping devices.

29. Device as defined in claim 27, wherein at least in a region of a supply point (18) and an output point (19) for a plurality of information carriers (11 through 15), a respective stationary operation device (20, 21) is provided, wherein the holding devices (9) are openable by means of said operation devices (20, 21).

30. Device as defined in claim 27, wherein the rotary cycle machine (6) is arranged at a supply point (18) of a supply device (22) for individual ones of a plurality of said information carriers (11 through 15).

31. Device as defined in claim 30, wherein the rotary cycle machine (6) is arranged on an output point (19) of an output device for the individual information carriers (11 through 15).

32. Device as defined in claim 11, wherein in addition to at least one stamping station (16), a chip decoding station and/or a magnet coding station and/or printing station with ink-jet or laser printing and/or an upper surface treatment station (46) and/or a camera checking station is provided, wherein in said upper surface treatment station (46), stamped characters provided on the information carrier (11 through 15) are treated.
